(19) United States
(12) Patent Application Publication
(10) Pub. No.: US 2026/0341284 A1
(43) Pub. Date: Oct. 29, 2026

(54) METHODS, APPARATUS AND SYSTEMS FOR PERFORMING PERCEPTUALLY MOTIVATED GAIN CONTROL

(71) Applicants: Dolby Laboratories Licensing Corporation, San Francisco, CA (US); DOLBY INTERNATIONAL AB, Dublin (IE)

(72) Inventors: Panji SETIAWAN, Munich (DE); Benjamin Gilbert MCDONALD, Arncliffe (AU); Rishabh TYAGI, Sydney (AU)

(73) Assignees: Dolby Laboratories Licensing Corporation, San Francisco, CA (US); DOLBY INTERNATIONAL AB, Dublin (IE)

(21) Appl. No.: 19/118,326

(22) PCT Filed: Sep. 1, 2023
(86) PCT No.: PCT/US2023/073365

§ 371 Date: Apr. 3, 2025

Related U.S. Application Data
(60) Provisional application No. 63/378,678, filed on Oct. 6, 2022.
(60) Provisional application No. 63/503,533, filed on May 22, 2023.

(51) Int. Cl. G10L 19/008

(52) U.S. Cl. CPC G10L 19/008

(57) ABSTRACT

Systems, methods, and computer program products for performing gain control on audio signals are provided. An automatic gain control system obtains a downmixed audio signal of an audio signal to be encoded. The system determines that an overload condition has occurred for a frame of the downmixed audio signal. Responsive to the overload condition, the system determines a gain transition function for the frame, wherein the gain transition function is based at least on a gain transition step size. The system applies the gain transition function to the frame to generate a gain adjusted frame of the downmixed audio signal. The system provides the gain adjusted frame and information indicative of the gain transition function for encoding by an encoder.

### CROSS-REFERENCE TO RELATED APPLICATIONS

This application claims priority from U.S. Provisional Application No. 63/378,678 filed on 6 Oct. 2022, and U.S. Provisional Application No. 63/503,533 filed on 22 May 2023, each of which is incorporated by reference herein in its entirety.

### TECHNICAL FIELD

This disclosure pertains to systems, methods, and media for adaptive gain control in an audio environment.

### BACKGROUND

Gain control may be used, for example, to attenuate signals to be within a range expected by an audio codec. To improve the perceptual quality of an audio signal to which gain control is applied at an encoder, and inverse gain control applied at a decoder, gain transition functions have been proposed to smoothly transition between the different gains applied to consecutive frames. If there is a drastic gain change between consecutive frames, this method may lead to audible artifacts. Further, in some cases the gain change between the determined gains of consecutive frames is too large and/or sudden for applying a smooth transition function. In this case, a hard transition may be used to ensure that the signal is within expected range. For example, a single bit may be used to convey the information that a hard transition is used between the gains of consecutive frames. This hard transition, however, may also lead to audible artifacts in the decoded and rendered audio signal which are worse than those introduced by the original overload condition. Thus, there is a need for improving the perceptual quality of an encoding/decoding systems using gain transition functions and for reducing the bits needed for encoding.

### NOTATION AND NOMENCLATURE

Throughout this disclosure, including in the claims, the terms “speaker,” “loudspeaker” and “audio reproduction transducer” are used synonymously to denote any sound-emitting transducer or set of transducers. A typical set of headphones includes two speakers. A speaker may be implemented to include multiple transducers, such as a woofer and a tweeter, which may be driven by a single, common speaker feed or multiple speaker feeds. In some examples, the speaker feed(s) may undergo different processing in different circuitry branches coupled to the different transducers.

Throughout this disclosure, including in the claims, the expression performing an operation “on” a signal or data, such as filtering, scaling, transforming, or applying gain to, the signal or data, is used in a broad sense to denote performing the operation directly on the signal or data, or on a processed version of the signal or data. For example, the operation may be performed on a version of the signal that has undergone preliminary filtering or pre-processing prior to performance of the operation thereon.

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X−M inputs are received from an external source) may also be referred to as a decoder system.

Throughout this disclosure including in the claims, the term “processor” is used in a broad sense to denote a system or device programmable or otherwise configurable, such as with software or firmware, to perform operations on data, which may include audio, or video or other image data. Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

### SUMMARY

In view of the above, the present disclosure provides methods, apparatus, and programs, as well as computer-readable storage media for improving automatic gain control, having the features of the respective independent claims.

According to an aspect of the disclosure, a method of performing gain control on audio signals is provided. The audio signal may be a higher order ambisonics, HOA, audio signal. In this method a downmixed audio signal of an audio signal to be encoded may be obtained. Obtaining the audio signal may include receiving the downmixed audio signal. Alternatively, it may include determining the downmixed audio signal from the audio signal to be encoded. Further, it may be determined that an overload condition has occurred for a frame of the downmixed audio signal. The overload condition may be a condition in which the frame of the downmixed audio signal exceeds a predefined signal range. The predefined signal range may be a signal range expected by the encoder. The encoder may be a core encoder. In response to determining that the overload condition has occurred a gain transition function for the frame may be determined. The gain transition function may be based at least on a gain transition step size. The gain transition function may be applied to the frame to generate again adjusted frame of the downmixed audio signal. The gain adjusted frame may be an attenuated frame or an amplified frame. The gain adjusted frame and information indicative of the gain transition function may be provided for encoding by an encoder.

By limiting the gain transition function to a gain transition step size, a smooth and not too sudden transition from consecutive gains can be achieved. The gain transition step size may be insufficient to attenuate all samples of a frame to the signal range required by a core encoder. The artefacts due to small overshoots are however less noticeable than a very sudden increase or decrease in gain parameters. Therefore, by allowing some values to be outside of the required signal range, an improved audio experience can be achieved when the signal is decoded, rendered and played back.

In some embodiments, the gain adjusted frame together with the information indicative of the gain transition function may be encoded.

In some embodiments, the downmixed audio signal may be a spatially encoded downmixed signal.

In some embodiments, the frame of the downmixed audio signal may be a current frame and the gain transition function is further based on a previous gain transition function applied to a frame preceding the current frame.

In some embodiments, the gain transition function may further depend on a smoothing function based on the gain transition step size.

In some embodiments, the gain transition function may include a transitory portion and a steady-state portion. The transitory portion may correspond to a transition from a gain associated with a preceding frame to the gain associated with the preceding frame adjusted by the gain transition step size.

In some embodiments, the gain associated with the preceding frame adjusted by the gain transition step size may be an attenuation by the gain transition step size or an amplification by the gain transition step size of the gain associated with the preceding frame depending on a gain adjustment target of the current frame.

In some embodiments, a length of the transitory portion may be limited by a delay introduced by a codec utilized by the encoder and decoder.

Thereby, the gain control does introduce substantially zero additional delay.

In some embodiments, the length of the transitory portion may be equal to or less than the number of samples used for an encoding operation by the encoder.

In some embodiments, the gain transition function may be defined as

$$t ( DBSTEP , l , j ) = \{ \begin{matrix}\begin{matrix}{p ( DBSTEP , l , j )}^{( e ( j ) - e ( j - 1 ) )} * \\ t ( DBSTEP , L - 1 , j - 1 )\end{matrix} , & l = 0 … {l}_{end} \\ \begin{matrix}{p ( DBSTEP , {l}_{end} , j )}^{( e ( j ) - e ( j - 1 ) )} * \\ t ( DBSTEP , L - 1 , j - 1 )\end{matrix} , & l = {l}_{end} + 1 … L - 1\end{matrix}$$

wherein DBSTEP is the gain transition step size, l is a sample index, j is a frame index, p( ) is a smoothing function, l_{end} represents the right-most index for which p( ) is defined and L is the number of samples of one frame.

In some embodiments, the gain transition step size may be a predefined value or may be determined from a set of predefined values of increasing size. The predefined value or the set of predefined values may be determined based on perceptive quality listening test or an objective quality measurement test. The perceptive quality listening test may be a Multi-Stimulus Test with Hidden Reference and Anchor, MUSHRA. The perceptive quality listening test may be part of a tuning process of the automatic gain control at the encoder and decoder.

In some embodiments, the method may further include determining an overload amount caused by the frame of the downmixed audio signal. Further, the gain transition step size may be determined from the set of predefined values of increasing size depending on the overload amount.

Thereby, the gain transition step size can be adapted to the rate of change needed between consecutive frames.

In some embodiments, applying the gain transition function to the frame for generating a gain adjusted frame of the downmixed signal may include applying the gain transition function to samples of the downmixed audio signal. A total number of the samples may correspond to the frame of the downmixed audio signal.

In some embodiments, encoding the gain adjusted frame together with the information indicative of the gain transition function may include determining an encoding scheme based on the gain transition function. In some cases, the encoding scheme may be determined based on the gain transition step size. In some cases, the encoding scheme may be determined based on whether the overload condition has been removed. The encoding scheme may be one of Modified Discrete Cosine Transformation, MDCT, or Algebraic Code Excited Linear Prediction, ACELP.

Thereby, the coding scheme can be optimized for the particular audio signal and the required gain transition step size.

According to a further aspect, a method of performing gain control on audio signals is provided. In this method an encoded frame of an audio signal may be received by a decoder. The encoded frame of an audio signal may be decoded to obtain a frame of a downmixed audio signal and information indicative of gain control applied by an encoder. An inverse gain transition function to be applied to the frame of the downmixed audio signal may be determined based at least in part on the information indicative of gain control applied by the encoder. The information indicative of gain control applied by the encoder may include a gain transition step size. The inverse gain transition function may be applied to the frame of the downmixed audio signal.

In some embodiments, the method may further include upmixing the downmixed audio signal to generate an upmixed audio signal. The upmixed audio signal may be suitable for rendering.

In some embodiments, the method may further include rendering the upmixed signal to produce rendered audio data.

In some embodiments, the method may further include playing back the rendered audio data using one or more of a loudspeaker or headphones.

In some embodiments, the inverse gain transition function may be determined by inverting a gain transition function applied by the encoder.

In some embodiments, the inverse gain transition function may include a transitory portion and a steady-state portion.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via an apparatus. For example, one or more devices may be capable of performing, at least in part, the methods disclosed herein. In some implementations, an apparatus is, or includes, an audio processing system having an interface system and a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is an illustrative schematic block diagram of a system for providing gain control of audio signals in the prior art.

FIGS. 2A and 2B are illustrative schematic block diagrams of a system for implementing adaptive gain control in accordance with some embodiments.

FIGS. 3A and 3B show examples of gain transition functions that may be implemented by an encoder and inverse gain transition functions that may be implemented by a decoder, respectively, in accordance with some embodiments.

FIG. 4 is a flowchart of an example process that may be performed by an encoder for implementing adaptive gain control in accordance with some embodiments.

FIG. 5 is a flowchart of an example process that may be performed by a decoder for implementing adaptive gain control in accordance with some embodiments.

FIG. 6 illustrates example use cases for an Immersive Voice and Services (IVAS) system in accordance with some embodiments.

FIG. 7 shows a block diagram that illustrates examples of components of an apparatus capable of implementing various aspects of this disclosure.

FIGS. 8A and 8B illustrate example embodiments of audio codecs utilizing a perceptually motivated gain control of downmixed signals, where the gain transition step-size is uniform.

FIGS. 9A and 9B illustrate example embodiments of audio codecs utilizing a perceptually motivated gain control of downmixed signals, where the gain transition step-size is non-uniform.

Like reference numbers and designations in the various drawings indicate like elements.

### DETAILED DESCRIPTION OF EMBODIMENTS

Some coding techniques for scene-based audio, stereo audio, multi-channel audio, and/or object audio rely on coding multiple component signals after a downmix operation. Downmixing may allow a reduced number of audio components to be coded in a waveform encoded manner that retains the waveform, and the remaining components may be encoded parametrically. On the receiver side, the remaining components may be reconstructed using parametric metadata indicative of the parametric encoding. Because only a subset of the components are waveform encoded and the parametric metadata associated with the parametrically encoded components may be encoded efficiently with respect to bit rate, such a coding technique may be relatively bit rate efficient while still allowing high quality audio.

One problem that may occur is that downmix channels determined by a spatial encoder may include signals with levels that are not suitable for subsequent processing by a core codec that constructs an audio signal bitstream. For example, in some cases, a downmix signal may have a level that is so high that the core codec is overloaded despite the original input signal not being overloaded in any of its component signals. This may cause severe distortions such as clipping in the reconstructed signal after decoding and rendering. This may cause substantial quality loss in the ultimately rendered signals. One potential solution may be to attenuate the input signal to avoid overloading of the core codec. However, this solution may have the drawback of increasing granular noise, because quantizers utilized to encode the signal may not be operating in an optimal range.

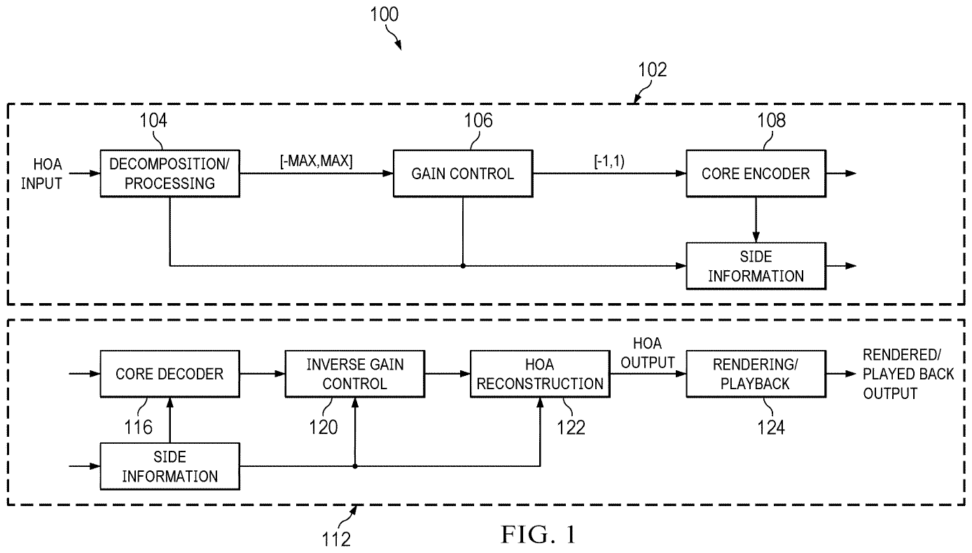

FIG. 1 shows a schematic block diagram of a conventional system 100 for performing gain control on encoded higher order Ambisonics (HOA) signals. The schematic diagram shown in FIG. 1 may be used for encoding and decoding MPEG-H signals. MPEG-H is a group of international standards under development by the International Organization for Standardization (ISO)/International Electrotechnical Commission (IEC) Moving Picture Experts Group (MPEG). MPEG-H has various parts, including Part 3, MPEG-H 3D Audio.

At an encoder 102, an input HOA signal is processed at 104. The processing may include decomposition, for example, in which downmix channels are generated. The downmix channels may include a set of signals which are bound by ┌−max, max┐ for a given frame. Because a core encoder 108 can encode signals within a range of [−1, 1), samples of the signals associated with the downmix channels that exceed the range of core encoder 108 may cause overload. To avoid overload, a gain control 106 adjusts the gain of the frame such that the associated signals are within the range of core encoder 108 (e.g., within [−1, 1)). Core encoder 108 may be considered the codec that generates an encoded bitstream. Side information generated by the decomposition/processing block 104, which may include metadata associated with parametrically encoded channels, or the like, may be encoded in a bitstream in connection with the signals produced as an output of core encoder 108.

The encoded bitstream is received by a decoder 112. Decoder 112 may extract the side information and a core decoder 116 may extract downmix signals. An inverse gain control block 120 may then reverse the gain applied by the encoder. For example, the inverse gain control block 120 may amplify signals that were attenuated by gain control 106 of encoder 102. The HOA signals may then be reconstructed by an HOA reconstruction block 122. Optionally, the HOA signals may be rendered and/or played back by rendering/playback block 124. Rendering/playback block 124 may include, for example, various algorithms for rendering the reconstructed HOA output, e.g., as rendered audio data. For example, rendering the reconstructed HOA output may involve distributing the one or more signals of the HOA output across multiple speakers to achieve a particular perceptual impression. Optionally, rendering/playback block 124 may include one or more loudspeakers, headphones, etc. for presenting the rendered audio data.

Gain control 106 may implement gain control using the following techniques. Gain control 106 may first determine an upper bound of the signal values in a frame. For example, for MPEG-H audio signals, the bound may be expressed as a product \sqrt{Kₘₐₓ}*O, where the product is specified in the MPEG-H standard. Given the upper bound, the minimum attenuation required may ensure that the scaled signal samples are bound by the interval [−1, 1). In other words, the scaled samples may be within the range of core encoder 108. This may be determined by applying the gain factor of 2^{-|e}^{ₘᵢₙ}^{|}, where |eₘᵢₙ|=ceil(log₂(\sqrt{Kₘₐₓ}*O)). By definition, eₘᵢₙ may be a negative number. In some embodiments, amplification may be limited by a maximum amplification factor 2^{e}^{ₘₐₓ}, where eₘₐₓ is a non-negative integer number. Accordingly, to perform both attenuation and amplification, a gain factor of 2^{c} can be defined, with the gain parameter e being a value in the range of [eₘᵢₙ, eₘₐₓ]. Consequently, the lowest number of bits required to represent the gain parameter e is determined as βₑ=ceil(log₂(|eₘᵢₙ|+eₘₐₓ+1)).

A gain factor gₙ(j), for a particular channel n and frame j may be determined by applying a one frame delay, which corresponds to one HOA block, and utilizing the following recursive operation:

$${g}_{n} ( j - 1 ) = {g}_{n} ( j - 2 ) * {2}^{{e}_{n} ( j - 1 )}$$

In the above, gₙ(j−2) represents a gain factor applied for the frame (j−2), and 2^{e}^{ₙ}^{(j-1)} represents the gain factor adjustment required to calculate the gain factor gₙ(j−1) for the frame j−1.

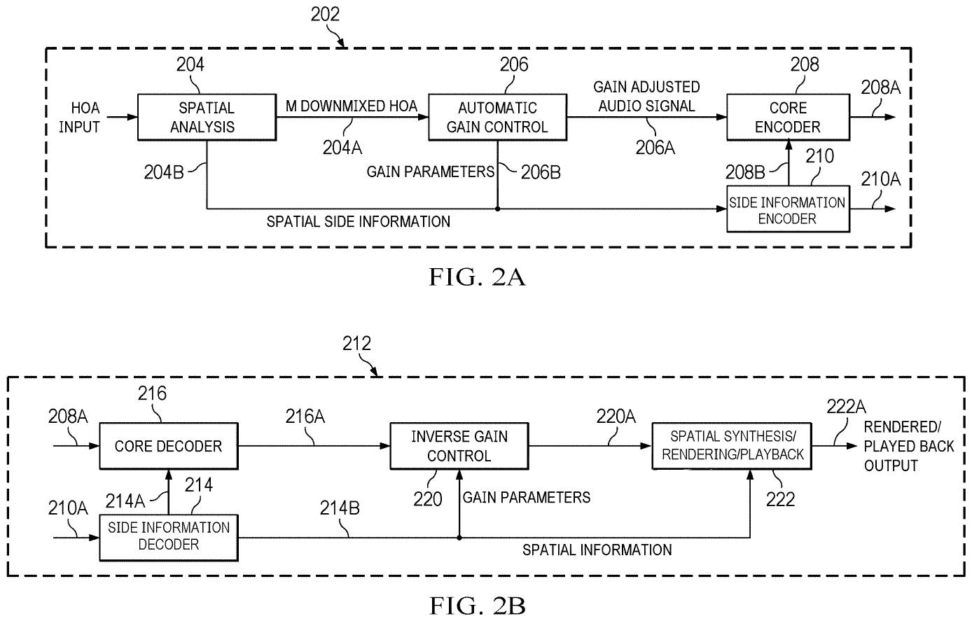

Disclosed herein are techniques for providing adaptive gain control. In particular, as described herein, gain parameters may be determined that do not produce an additional delay, because gain parameters may be determined based on lookahead samples generated for use by a codec. The codec may be used by a perceptual encoder. Determination of gain transition functions are shown in and described below in connection with FIGS. 2-5.

FIGS. 2A and 2B show a schematic block diagram of an encoder 202 and a decoder 212, respectively, for performing low-delay adaptive gain control in accordance with exemplary embodiments. At encoder 202, an input HOA signal (or first-order Ambisonics (FOA)) signal undergoes processing by a spatial analysis block 204. For an N channel HOA input, spatial analysis block 204 may generate and output a set of M downmix channels 204A. The number of downmix channels in the set of M downmix channels 204A may be in a range 1≤M≤N. Additionally, spatial analysis block 204 may generate and output spatial side information 204B for reversing the downmix operation.

For example, for an FOA input, the downmix channels may include a primary downmix channel W′, which can be generated by mixing the omnidirectional input signal W with the directional input signals X, Y and Z using a variety of mixing gains, and up to 3 residual channels, X′, Y′, and Z′, each corresponding to signal components in the X, Y, and Z signals that cannot be predicted from the primary downmix signal. In one example, spatial analysis block 204 utilizes the Spatial Reconstruction (SPAR) technique. SPAR is further described in D. McGrath, S. Bruhn, H. Purnhagen, M. Eckert, J. Torres, S. Brown, and D. Darcy Immersive Audio Coding for Virtual Reality Using a Metadata-assisted Extension of the 3GPP EVS Codec IEEE International Conference on Acoustics, Speech and Signal Processing (ICASSP), 2019, pp. 730-734, which is hereby incorporated by reference in its entirety. In other examples, spatial analysis block 204 may utilize any other suitable linear predictive codec of energy compacting transform, such as a Karhunen-Loeve Transform (KLT) or the like. Core encoder 208 may be considered the codec that generates an encoded audio bitstream 208A. In some implementations, the core encoder 208 and a core decoder 216 may introduce some lookahead samples that are to be utilized by an adaptive gain control 206 to determine gain parameters to avoid adding extra delay (zero additional delay) to the whole coding process.

The signals associated with the M downmix channels 204A may then be analyzed by an adaptive gain control 206. Adaptive gain control 206 may determine whether signals associated with any of the M downmix channels 204A surpass the audio amplitude range expected by core encoder 208, and therefore, will overload core encoder 208. In some embodiments, in an instance in which adaptive gain control 206 determines that no gain is to be applied, such as responsive to a determination that none of the signals of the M downmix channels 204A exceed an expected range of core encoder 208, adaptive gain control 206 may set a flag indicating that no gain control is applied. The flag indication may be performed by setting a value for the flag, for example by setting a value of a single bit. In instances in which adaptive gain control 206 determines that no gain is to be applied, adaptive gain control 206 may not set the flag, thereby, preserving one bit (e.g., the bit associated with the flag). For example, in some implementations, if a spatial metadata bitstream and/or a core encoder bitstream (which may be a perceptual encoder bitstream) are self-terminating, the presence of a gain control flag may be determined by determining whether there are any unread bits in the bitstream. The unread bits may be left over bits in the bitstream. In cases where no overload condition exists, adaptive gain control 206 may output the M downmix channels 206A. The M downmix channels 206A may then be passed to core encoder 208 for encoding in a bitstream 208A.

Conversely, in instances in which adaptive gain control 206 determines that gain is to be applied, adaptive gain control 206 may determine gain parameters and apply gain(s) to the M downmix channels according to the determined gain parameters. The M downmix channels with gain applied 206A may then be passed to core encoder 208 for encoding in a bitstream. Further, adaptive gain control 206 may output side information on gain control 206B. Information regarding the flag may be comprised in the side information on gain control 206B. Side information encoder 210 may encode spatial side information 204B together with gain parameters 206B as metadata 210A for transmission in a bitstream. The decoder 212 may then extract and use this metadata to upmix the downmixed channels and reverse the gain adjustment. For example, metadata 210A may later be utilized to reconstruct a representation of the original audio input that was downmixed by spatial analysis unit 204. Side information encoder 210 may additionally provide side information 208B to core encoder 208. Core encoder 208 then may use side information 208B to choose between coding techniques. Both the encoded bitstream 208A and the encoded bitstream with metadata 210A may be multiplexed to form final bitstream output by encoder 202.

In some implementations, adaptive gain control 206 may determine a gain transition function that transitions between a gain parameter e(j−1) associated with a previous frame (e.g., the j−1th frame) and a gain parameter of the current frame, e(j). The gain transition function may be applied by adaptive gain control 206 on a frame by frame basis, wherein each frame may be a frame of one of the M downmix channels 204A. In some implementations, the gain transition function may smoothly transition the gain parameter across the samples of the j*frame from the value of the gain parameter at the j−1^{th} frame (e.g., e(j−1)) to the gain parameter of the current frame (e.g., e(j)). Accordingly, the gain transition function may include two portions: 1) a transitory portion in which the gain parameter is transitioning across the samples of the transition portion from the gain parameter of the preceding frame to the gain parameter of the current frame; and 2) a steady-state portion in which the gain parameter has the value of the gain parameter of the current frame for the samples of the steady-state portion.

In some embodiments, in an instance in which the gain applied to the current frame is less than the gain applied to the previous frame, the transitory portion may be referred to as having a transitory type of “fade,” because the amount of attenuation increases across the samples of the current frame. The case where the gain applied to the current frame is less than the gain applied to the previous frame may be represented as e(j)>e(j−1). In some embodiments, in an instance in which the gain applied to the current frame is greater than the gain applied to the previous frame, the transitory portion may be referred to as having a transitory type of “reverse fade,” or “un-fade,” because the amount of attenuation decreases across the samples of the current frame. The case where the gain applied to the current frame is greater than the gain applied to the previous frame may be represented as e(j)<e(−1). In some embodiments, in an instance in which the gain applied to the current frame is the same as the gain applied to the current frame, the transitory portion may be referred to as having a transitory type of “hold,” in which the transitory portion is not transitory and rather has the same value as the steady-state portion. The case where the gain applied to the current frame is the same as the gain applied to the current frame may be represented as e(j)=e(j−1).

In some embodiments, the gain transition function depends on a gain transition step size. The gain transition step size may limit the amount of a possible transition from a preceding frame to the current frame. This is motivated by the fact that smaller and smoother gain/attenuation changes which potentially allow overloads to happen during the transition is perceptually better than having a bigger change, especially when this is subject to further processing by a lossy core encoder requiring the mentioned predefined value range as inputs. By predefining parameters of the gain transition function in this way, the impact of the parameters on objective quality or perceived quality can be evaluated. The perceived quality may be measured based on known perceptive quality listening tests like the Multi-Stimulus Test with Hidden Reference and Anchor, MUSHRA. The perceptive quality listening test may be part of a tuning process of the automatic gain control at the encoder and decoder. In particular, parameters like the gain transition step size may be tuned for a particular audio scenario and codec until an optimum perceived audio quality is reached. The tuned parameters are then used by the encoding/decoding system.

In an example implementation, the processed output 206A of the automatic gain control 206 is further coded by a lossy core codec based on Algebraic Code Excited Linear Prediction (ACELP) coding which does not aim to do waveform reconstruction. It has been observed that applying bigger gain steps to ACELP input and output leads to audible glitches in the reconstructed signal and degrades the overall performance of the codec.

In some implementations, when an overload for a current frame is detected, the automatic gain control 206 may also determine the attenuation amount necessary for the frame to be inside the expected range of the core encoder 208. If there is a large difference between the attenuation needed between consecutive frames, applying a transition function to achieve the required range [−1,1) by the core encoder 208 may lead to audible artifacts when the audio signal is rendered at the decoder. Instead of applying a transition function to keep each frame inside or at the limit of the required range, the transition function may be limited to a specific gain transition step size. Thereby, irrespective of the attenuation amount necessary for achieving the expected range of the core encoder 208, the transition function can only attenuate a single frame by an amount equal to the gain transition step size, i.e., ±DBSTEP dB. Therefore, as an example, if the attenuation of a previous frame is −10 dB, the attenuation applied to the first sample of the current frame will be −10 dB, and the attenuation applied to the last sample of the current frame will be −10 dB±DBSTEP. To be precise, if the overload amount does not change from the previous frame to the current frame, the gain transition will be a constant value, e.g., −10 dB. If the attenuation amount needs to be changed, the gain transition function will transition from the attenuation of the previous frame to the last sample of the current frame by ±DBSTEP dB.

In some implementations, DBSTEP may be chosen such that the attenuation amount applied by the automatic gain control 206 is not sufficient for keeping the frame inside the expected signal range of the core encoder 208. For example, DBSTEP may be a fixed value. By allowing frames to be outside of the range of [−1,1) when a sharp change in attenuation is required, strong attenuation differences between consecutive frames can be avoided. Therefore, instead of forcing the frame inside the range of [−1,1a) by either a transition function or a static gain change, the frame is attenuated by a fixed amount with respect to the attenuation amount of the previous frame. By using the transition function with a specific gain transition step size, perceptual audio quality may be improved, as a distortion due to the frame being outside the range of [−1,1) is less noticeable compared to distortions caused by a sharp attenuation difference between consecutive frames. Further, an exception flag for switching between a smooth transition and a static gain change can be avoided. Thereby, 1 bit can be saved at the core encoder 208.

In some implementations, DBSTEP may be a single value, e.g., −1 dB. Alternatively, DBSTEP may be chosen from a set of increasing fixed values, e.g., −1 dB, −3 dB, −6 dB. In this case, the value for DBSTEP may be chosen depending on amount of overload caused by the frame without attenuation.

In some implementations, the automatic gain control is configured to have the ability to specify a set of target gain values Gr, which may be represented as a table of numbers, e.g., integers, indicating the multiples of DBS attenuation provided at each step. This is motivated by the fact that smaller changes provide perceptual benefits, however a higher level of possible attenuation may be required for some signals. Specifying these non-uniform absolute steps allows for a wider attenuation range to be covered while providing the benefits of smaller steps for many likely cases. For example, the set of Gr={0, 1, 3, 6} with a DBS of −2 dB, will have absolute target gains of {DBS*G_{T}}={0 dB, −2 dB, −6 dB, −12 dB}, taking consecutive steps DBSTEP of {−2 dB, −4 dB, −6 dB}.

One or more of such tables of integers may be specified and the information on the choice of a particular table being used at the encoder side may be signaled/transmitted to the decoder side. As opposed to the application of uniform steps which is resulting in a single uniform gain transition shape, the application of non-uniform steps is resulting in non-uniform gain transition shapes (level-dependent transition functions).

In some implementations, when DBSTEP is insufficient to attenuate the current frame to the range of [−1,1), DBSTEP may be applied to frames following the current frame, until the range of [−1,1) is achieved.

In some implementations, output level and attenuation information from the automatic gain control 206 system may be used in the decision-making process in other systems such as the core encoder 208. While the relaxed requirement can provide perceptual benefits, it can impact the core encoder 208 by either introducing a change in gain or by not meeting the strict requirement and allowing overload conditions to remain. Information such as whether the gain control did or did not meet the requirement, if any or how much gain was applied can be output and passed to the core encoder. This allows better decisions to be made such as choosing a coding method which is better able to handle gain changes or out of range samples. As an example, when large gain/attenuation steps are applied, the core encoder 208 may use a waveform coding technique like MDCT based coding instead of a predictive ACELP coding technique.

In some embodiments, a transitory portion of a gain transition function may be determined using a prototype shape of a transitory part of a gain transition function, where the prototype shape is scaled based on the difference between the gain parameter of the current frame and the gain parameter of the preceding frame. For example, the prototype shape may be scaled based on e(j)−e(j−1). A gain transition function utilizing such a protype function p may be represented as:

$$t ( DBSTEP , l , j ) = \{ \begin{matrix}\begin{matrix}{p ( DBSTEP , l , j )}^{( e ( j ) - e ( j - 1 ) )} * \\ t ( DBSTEP , L - 1 , j - 1 )\end{matrix} , & l = 0 … {l}_{end} \\ \begin{matrix}{p ( DBSTEP , {l}_{end} , j )}^{( e ( j ) - e ( j - 1 ) )} * \\ t ( DBSTEP , L - 1 , j - 1 )\end{matrix} , & l = {l}_{end} + 1 … L - 1\end{matrix}$$

Wherein, l_{end} represents the right-most index for which p is defined and L is the number of samples of one frame.
For example, the prototype shape of the transitory part gain can be defined as:

$$p ( DBSTEP , l , j ) = 1 + a ( DBSTEP ) \cdot ( cos ( π \cdot \frac{l}{L - 1} ) - 1 )$$

### Wherein

$$a ( DBSTEP ) = 0.5 \cdot ( 1 - 10 \frac{DBSTEP}{20} )$$

and L here is the number of samples in a frame for which p is defined. L may be l_{end}+1 for example.

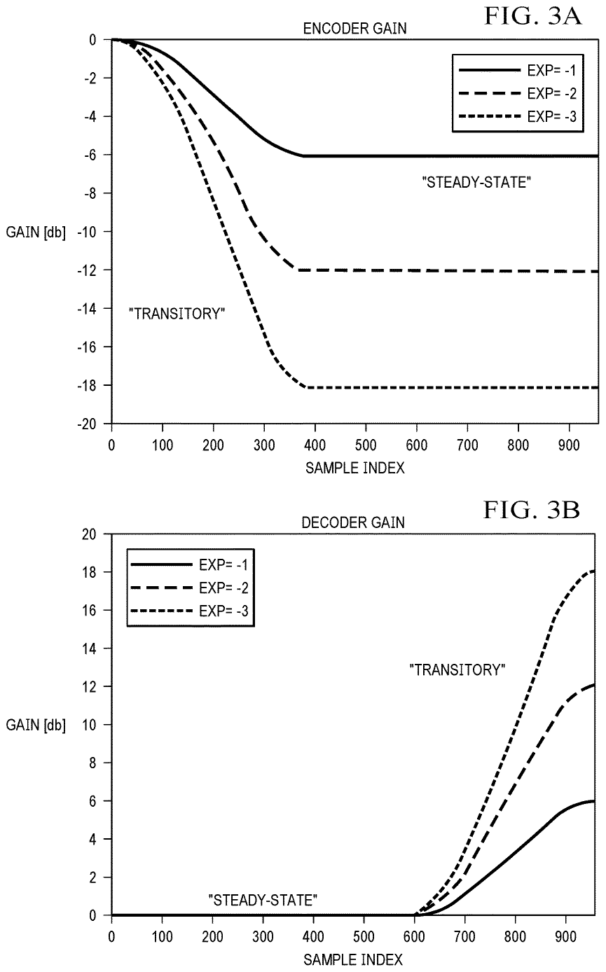

Examples of gain transition functions, each having a transitory portion having a transitory type of “fade,” are shown in FIG. 3A. In the examples shown in FIG. 3A, each gain transition function has a transitory portion that begins at sample 0, which may correspond to the beginning of the current frame, with a gain of 0 dB, where 0 dB is the gain parameter of the preceding frame (e.g., the j−1^{th} frame). In the example shown in FIG. 3A, the transitory portion of each gain transition function changes over the course of about 384 samples to the steady-state portion of the gain transition function. For each of the three gain transition functions shown in FIG. 3A, the steady-state portion corresponds to a different gain transition step size for the j^{th} frame, with an increase in (negative) gain of 6 dB, 12 dB, and 18 dB, respectively, relative to the gain of the preceding frame. In other words, as shown in FIG. 3A, for the three gain transition functions, exp=−[e(j)−e(j−1)]=−1, −2, and −3, respectively. For each of the gain transition functions shown in FIG. 3A, the transitory portion is of the same length (e.g., about 384 samples). Note that the length of the steady-state portion may correspond to an offset related to the delay introduced by the codec, e.g., 12 milliseconds in the example shown in FIG. 3A. Correspondingly, the length of the transitory portion may be related to the reciprocal of the offset. In the example shown in FIG. 3A, the length of the transitory portion is the frame length (e.g., 20 milliseconds) minus the codec delay (e.g., 12 milliseconds). Note that the codec delay may be the overall coder algorithmic delay excluding the frame size delay.

Additionally, gain transition functions having a transitory portion of a transitory type of “reverse fade” or “un-fade” may be represented as mirror images flipped across a horizontal line of the gain transition functions shown in FIG. 3A. By way of example, the horizontal line may be the x-axis.

Referring back to FIG. 2B, decoder 212 may receive, as an input, the encoded audio bitstream 208A and the metadata bitstream 210A and can reconstruct the HOA signals, e.g., for rendering, or directly render to a desired output format. In some embodiments, a core decoder 216 receives the encoded audio bitstream 208A. Additionally, core decoder 216 may receive information 214A extracted from metadata bitstream 210A by side information decoder 214. The core decoder 216 may decode the encoded audio bitstream 208A based on information 214A or without any side information knowledge and outputs M gain adjusted downmixed channels 216A to an inverse gain control 220. Side information decoder 214 further extracts gain parameters and spatial side information and transmits this information 214B to inverse gain control 220 and spatial synthesis/rendering/playback block 222. Inverse gain control 220 then may obtain the gain parameters that were applied by encoder 202 from information 214B. For example, in some implementations, inverse gain control 220 may retrieve the gain transition step size DBSTEP and/or an indication of an arithmetic factor related to DBSTEP, applied by encoder 202 from information 214B. Additionally, inverse gain control block 220 may retrieve, e.g., from memory, the shape of the transition function, i.e., a shape of the prototype function p, which is also referred to as smoothing function. Inverse gain control block 220 may then reverse the gain applied by encoder 202 using the obtained gain parameters and outputs M downmixed channels 220A. For example, in some implementations, inverse gain control 220 may construct an inverse gain transition function that transitions from the gain parameter of the preceding frame to the gain parameter of the current frame. In some implementations, the inverse gain transition function may be the gain transition function applied by encoder 202 mirrored across a center vertical line and vertically adjusted. By way of example, the vertical line may be the y-axis.

Turning to FIG. 3B, an example of an inverse gain transition function that would be applied by a decoder responsive to the gain transition function shown in FIG. 3A being applied by an encoder is shown in accordance with some implementations. As illustrated, the inverse gain transition function has a steady-state portion and a transitory portion. The durations of the steady-state portions and the transitory portions of the inverse gain transition function may correspond to, e.g., be the same as, the durations of the corresponding steady-state portions and transitory portions of the gain transition function, as illustrated in FIGS. 3A and 3B. As illustrated, each inverse gain transition function shown in FIG. 3B begins at 0 dB and transitions to −DBSTEP for the current frame. That is, each inverse gain transition functions begins at 0 dB corresponding to the inverse gain applied to the preceding frame j−1. Where the gain applied by the encoder corresponds to an attenuation, indicated with a gain of less than 0 dB as shown in the gain transition function of FIG. 3A, the inverse gain applied by the decoder corresponds to an amplification with a gain of greater than 0 dB as shown in the gain transition function of FIG. 3B. Conversely, in instances where the gain applied by the encoder corresponds to an amplification, e.g., with a gain of greater than 0 dB, the inverse gain applied by the decoder corresponds to an attenuation, e.g., with a gain of less than 0 dB.

Referring back to FIG. 2B, after the inverse gain has been applied, the M downmix channels with inverse gain applied 220A are provided to a spatial synthesis/rendering/playback block 222. Spatial synthesis/rendering/playback block 222 may reconstruct the HOA signals using information 214B. For example, in instances in which spatial analysis block 204 utilizes SPAR techniques for spatial encoding, spatial synthesis/rendering/playback block 222 may utilize SPAR techniques to reconstruct one or more channels which were encoded using metadata 210A. The reconstructed HOA output may then be rendered directly or provided to another entity for rendering. Spatial synthesis/rendering/playback block 222 may include, for example, various algorithms for rendering the reconstructed HOA output, e.g., as rendered audio data. For example, rendering the reconstructed HOA output may involve distributing the one or more signals of the HOA output across multiple speakers to achieve a particular perceptual impression. Optionally, spatial synthesis/rendering/playback block 222 may include audio playback devices, e.g., one or more loudspeakers, headphones, etc., for presenting the rendered audio data.

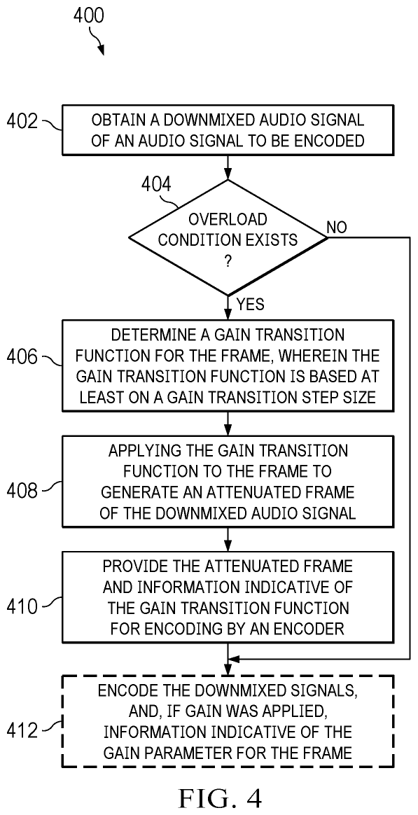

FIG. 4 shows an example of a process 400 for determining gain parameters and applying gain to downmixed signals according to the determined gain parameters in accordance with some implementations. In some implementations, blocks of process 400 may be performed by an encoder device. In some implementations, blocks of process 400 may be performed in an order other than what is shown in FIG. 4. In some implementations, two or more blocks of process 400 may be performed substantially in parallel. In some implementations, one or more blocks of process 400 may be omitted.

At 402, process 400 may obtain downmixed audio signal(s) associated with a frame of an audio signal to be encoded. The downmixed audio signal(s) may be associated with a frame of the audio signal to be encoded. For example, in some implementations, process 400 may use any suitable spatial encoding technique to determine a set of downmixed channels. Examples of spatial encoding techniques include SPAR, a linear predictive technique, or the like. The set of downmixed channels may include anywhere from one to N channels, where N is the number of input channels, e.g., in the case of FOA signals, N is 4. The downmixed signals may include audio signals corresponding to the downmixed channels for a particular frame of the audio signal.

At 404, process 400 may determine whether an overload condition exists for a codec, such as for the Enhanced Voice Services (EVS) codec, and/or for any other suitable codec. For example, process 400 may determine that an overload condition exists responsive to determining that signals corresponding to a frame of the downmix audio signal(s) exceed a predetermined range, e.g., [−1, 1), and/or any other suitable range.

If, at 404, it is determined that no overload condition exists (“no” at 404), process 400 can proceed to 412 and can encode the downmixed signals. For example, in some implementations, process 400 can generate a bitstream that encodes the downmixed signals in connection with side information, such as metadata, that can be utilized by a decoder to upmix the downmixed signals, e.g., to reconstruct a FOA or HOA output.

Conversely, if, at 404, it is determined that an overload condition exists (“yes” at 404), process 400 can proceed to 406 and can determine a gain transition function for the frame that causes the overload condition to be avoided or if the change of the overload condition from one frame to the next frame is larger than the gain transition step size, the overload is at least reduced. Further, in 406, the gain transition function may be based on the gain transition step size. Additionally, the gain transition function may be based on a shape of a smoothing function. Further, as described above in connection with FIG. 2, the gain transition function may have a transitory portion and a steady-state portion, where the steady-state portion corresponds to the gain factor for the current frame, and the transitory portion corresponds to a sequence of intermediate gain factors for a subset of samples of the current frame that transition from the gain factor at the end of the preceding frame to the gain factor of the preceding frame ±DBSTEP.

In instances in which the gain parameter of the preceding frame corresponds to less attenuation than the gain parameter of the current frame, the transitory portion may be referred to as having a transitory type of “fade.” Conversely, in instances in which the gain parameter of the preceding frame corresponds to more attenuation than the gain parameter of the current frame, the transitory portion may be referred to as having a transitory type of “reverse fade” or “un-fade.” In instances in which the gain parameter of the preceding frame is the same as the gain parameter of the current frame, the transitory portion may be referred to as having a transitory type of “hold,”. In instances in which the transitory portion has a transitory type of “hold,” the value of the gain transition function during the transitory portion may be the same as the value of the gain transition function during the steady-state portion. As described above in connection with FIG. 2, the duration of the transitory portion of the gain transition function may correspond to a delay duration utilized by a codec.

At 408, process 400 may apply the gain transition function to the downmixed signals associated with the frame. For example, in some implementations, process 400 may scale the samples of the downmixed signals by gain factors indicated by the gain transition function. As a more particular example, in some implementations, a first sample of the current frame may be scaled by a gain factor corresponding to the gain parameter of the preceding frame, a last sample of the current frame may be scaled by a gain factor corresponding to the gain parameter of the previous frame±DBSTEP, and intervening samples may be scaled by gain factors corresponding to the gain parameters of the transitory or steady-state portions of the gain transition function.

In some implementations, the gain transition function may be applied to only the downmixed signals of the downmix channels for which the overload condition was detected at block 404. For example, in an instance in which an overload condition was detected for the Y′ channel and the X′ channel, separate gain transition functions may be determined for each of the Y′ channel and the X′ channel, and applied to the signals of the Y′ channel and the X′ channel. Continuing with this example, the gain transition function may not be applied to the W‘ and Z’ channels. In such instances, indications of the channels to which gain transition functions are applied, as well as the corresponding gain parameters for each channel may be encoded, e.g., at block 412. Alternatively, in some implementations, in instances in which an overload condition exists for only one downmix channel, the corresponding gain transition function may be applied to all downmix channels. In such instances, because the gain transition function is applied to all channels, indications of channels to which gain has been applied need not be transmitted, which may lead to increased bit rate efficiency.

At 410, process 400 may provide the attenuated signal and information indicative of the gain transition function to an encoder for encoding. Information indicative of the gain transition function may the gain transition step size and/or an arithmetic factor related to the gain transition step size. Additionally, the shape of the smoothing function may be provided to the encoder for encoding.

At 412, process 400 can encode the downmixed signals and, if gain was applied, information indicative of the gain parameter(s) for the frame. In instances in which gain was applied, the encoded downmixed signals may be the downmixed signals after application of the gain transition function at block 408. The downmixed signals and any information indicative of gain parameters may be encoded by a codec to generate an encoded bitstream, such as the EVS codec, or the like, in connection with any side information, such as metadata, that may be used by a decoder to reconstruct or upmix the downmixed signals. The encoded bitstream together with the metadata may then be stored and/or transmitted to a receiving device with the ability to reverse the processing steps of the encoder.

It should be noted that, in some implementations, process 400 can encode the gain parameters in a set of bits. In some implementations, the gain transition function may indicate a prototype/smoothing function associated with the transitory portion of the gain transition function.

In instances in which adaptive gain control is enabled per channel such that unique gain transition functions are applied to each downmix channel associated with signals that trigger an overload condition, x bits may be utilized for each channel for which gain control is enabled, with an additional one bit indicator per channel indicating that gain parameters have been encoded. In such an instance, a total number of bits used transmit gain control information is N_{dmx}+x*N_{agc}, where N_{dmx} represents the number of downmix channels (and where a single bit is utilized to indicate, for each of the N_{dmx} channels, whether gain control is enabled), and where N_{agc} represents the number of channels for which gain control has been enabled. It should be noted that, in instances in which gain control is not enabled for a particular frame, N_{dmx} bits may be used to indicate that gain control is not enabled, e.g., 1 bit for each of the N_{dmx} channels. Note that, in instances in which the number of downmix channels is 1, e.g., only the W channel is waveform encoded, the total number of bits used to transmit gain control information is represented by x*N_{agc}. For example, given one downmix channel, if gain control is not enabled for the one downmix channel (e.g., N_{agc}=0), the number of bits used is 0. Continuing with this example, if gain control is enabled, (e.g., N_{agc}=1), the number of bits used is x.

In instances in which a single gain transition function associated with a downmix channel that triggers an overload condition is applied to all downmix channels, fewer bits may be used to transmit the gain control information. For example, a single gain parameter for the current frame is transmitted using x bits.

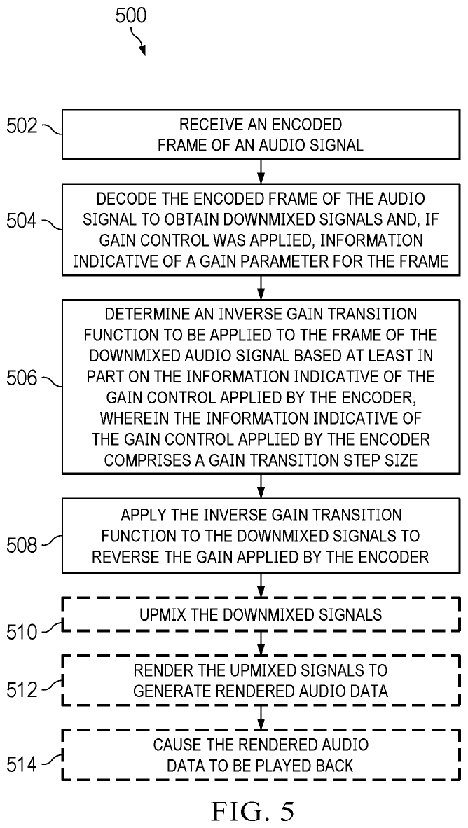

FIG. 5 shows an example of a process 500 for obtaining gain parameters utilized by an encoder and applying an inverse gain transition function based on the obtained gain parameters in accordance with some implementations. In some implementations, blocks of process 500 may be performed by a decoder device. In some implementations, blocks of process 500 may be performed in an order other than what is shown in FIG. 5. In some implementations, two or more blocks of process 500 may be performed substantially in parallel. In some implementations, one or more blocks of process 500 may be omitted.

Process 500 may begin at 502 by receiving an encoded frame of an audio signal. The received frame (e.g., the current frame) is generally referred to herein as the j^{th} frame. The received frame may be immediately after a previously received frame, or may be a frame that is not immediately after a previously received frame.

At 504, process 500 can decode the encoded frame of the audio signal to obtain downmixed signals, and, if gain control was applied by the encoder, information indicative of gain control applied to the current frame. Information indicative of gain control applied to the current frame may be the gain transitions step size applied by an encoder. Additionally, Information indicative of gain control applied to the current frame may be a shape of a smoothing function of a gain transition function applied by an encoder. In instances in which the encoder applies gain control on a per-channel basis, process 500 may additionally identify which downmix channels gain control was applied to.

At 506, process 500 may determine an inverse gain transition function based on the gain transition step size. In some implementations, process 500 may further determine the inverse gain transition function based on the shape of the smoothing function. The inverse gain transition function may be calculated based on the gain transition function, or it may be chosen from a number of predefined inverse gain transition functions.

In some implementations, process 500 may determine the inverse gain transition function to be the inverse of the gain transition function applied at the encoder. For example, the inverse gain transition function may correspond to the gain transition function mirrored across a horizontal line and adjusted. Mirroring and adjustment may be along the x-axis. An example of such an inverse gain transition function is shown in and described above in connection with FIG. 3B. In some implementations, the inverse gain transition function may have a steady-state portion that corresponds to the gain applied to the preceding frame. The inverse gain transition function may then have a transitory portion that is the inverse of the transitory portion of the gain transition function applied at the encoder. For example, in an instance in which the gain applied to the current frame corresponds to more attenuation relative to the preceding frame, the inverse gain transition function may have a transitory portion that transitions from less amplification to more amplification. Conversely, in an instance in which the gain applied to the current frame corresponds to less attenuation relative to the preceding frame, the inverse gain transition function may have a transitory portion that transitions from more amplification to less amplification. A duration of the transitory portion may relate to the delay introduced by the codec, where the duration of the transitory portion is the frame length (e.g., 20 milliseconds) minus the codec delay (e.g., 12 milliseconds). Note that, in instances in which the delay introduced by the codec is longer than a frame length, the inverse gain transition may be applied with a delay of one frame. In some instances, the delay may be obtained by process 500 (e.g., by the decoder) from the gain control bits. The inverse gain transition function may also serve to attenuate signals that were amplified by the gain control of the encoder.

At 508, process 500 may apply the inverse gain transition function to the downmixed signals to reverse the gain applied by the encoder. For example, application of the inverse gain transition function may cause downmixed signals that were attenuated by the encoder to be amplified to reverse the attenuation. As another example, application of the inverse gain transition function may cause downmixed signals that were amplified by the encoder to be attenuated to reverse the amplification. The output of step 508 may then be M downmix channels with the same gain as the M downmix channels after step 402 of process 400.

At 510, process 500 can upmix the downmixed signals. Upmixing may be performed by a spatial encoder. In some examples, the spatial encoder may utilize SPAR techniques. The upmixed signals may correspond to a reconstructed FOA or HOA audio signal. In some implementations, process 500 may upmix the signals using side information, e.g., metadata, encoded in the bitstream, where the side information may be utilized to reconstruct parametrically-encoded signals. In some implementations, block 510 may be optional, e.g., when the downmixed signals can be rendered directly.

In some implementations, at 512, process 500 may render the upmixed signals to generate rendered audio data. In some implementations, process 500 may utilize any suitable rendering algorithms to render a FOA or HOA audio signal, e.g., to rendered scene-based audio data. In some implementations, rendered audio data may be stored in any suitable format, e.g., for future presentation or playback. In some implementations, block 512 is optional and therefore may be omitted.

In some implementations, at 514, process 500 may cause the rendered audio data to be played back. For example, in some implementations, the rendered audio data may be presented via one or more of loudspeakers and/or headphones. In some implementations, multiple loudspeakers may be utilized, and the multiple loudspeakers may be positioned in any suitable positions or orientations relative to each other in three dimensions. In some implementations, process 514 is optional and therefore may be omitted.

As described above in connection with FIG. 4, gain control information, e.g., information indicative of gain parameters, may be encoded using a set of gain control bits. In some implementations, different gain transition functions may be determined for each downmix channel for which an overload condition is detected. In such implementations, gain control bits are needed to indicate whether or not gain control is being applied to each of the downmix channels, and gain transition function parameters are encoded for each of the downmix channels for which gain control is applied, as described above in connection with FIG. 4. Alternatively, in some implementations, a single gain transition function that is determined based on one downmix channel for which an overload condition exists may be applied to all of the downmix channels. In such implementations, fewer gain control bits are needed, because a separate bit flag is not required to signify whether or not gain control has been applied for each downmix channel, thus leading to a more bitrate efficient encoding.

A more bitrate efficient encoding by applying the same gain transition function to all downmix channels, including for dowxnmix channels for which no overload condition exists, may result in degradation of perceptual quality, by, for example, attenuating signals for which no overload of the codec exists. By contrast, utilizing a more targeted gain control, in which gain control is applied in a targeted manner to each downmix channel, may require more bits to transmit gain control information. However, utilizing additional bits to transmit targeted, e.g., channel-specific, gain control information may require re-allocation of bits typically used to waveform encode the downmix channels, which may in some cases reduce perceptual quality. Accordingly, there may be a situation-dependent tradeoff between applying the same gain transition function to all downmix channels and applying channel-specific gain control. Regardless of whether gain control is applied across all downmix channels or on a targeted per-channel basis, bits associated with gain control information may be allocated from bits that would typically be used for waveform encoding of the downmix channel and/or from bits that would typically be used for encoding side information, such as metadata, used to reconstruct an FOA or HOA signal from the downmix channels, thereby reducing the number of available bits for encoding either the downmix channels or the side information.

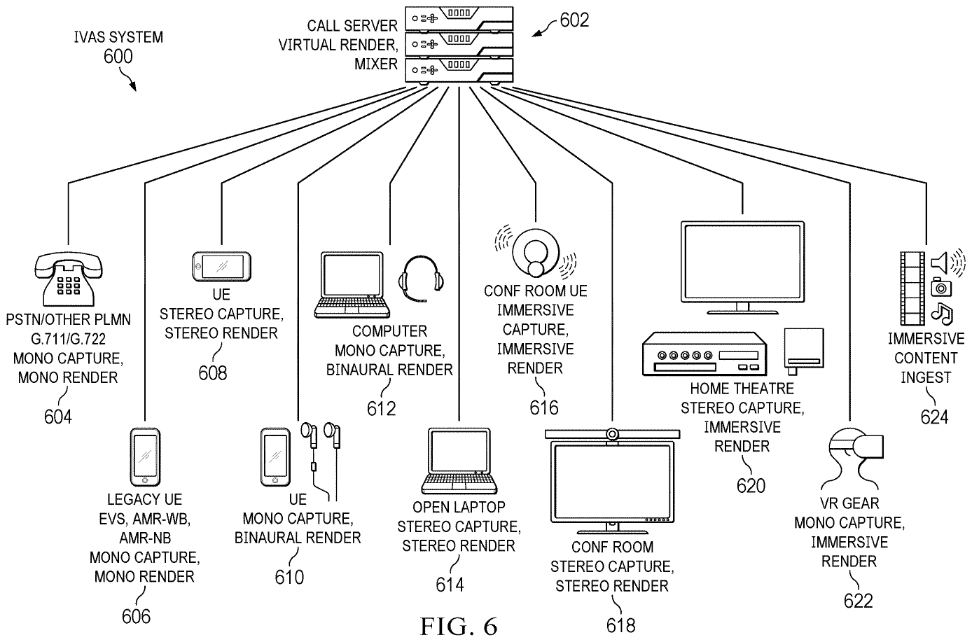

FIG. 6 illustrates example use cases for an IVAS system 600, according to an embodiment. In some embodiments, various devices communicate through call server 602 that is configured to receive audio signals from, for example, a public switched telephone network (PSTN) or a public land mobile network device (PLMN) illustrated by PSTN/OTHER PLMN 604. Use cases support legacy devices 606 that render and capture audio in mono only, including but not limited to: devices that support enhanced voice services (EVS), multi-rate wideband (AMR-WB) and adaptive multi-rate narrowband (AMR-NB). Use cases also support user equipment (UE) 608 and/or 614 that captures and renders stereo audio signals, or UE 610 that captures and binaurally renders mono signals into multi-channel signals. Use cases also support immersive and stereo signals captured and rendered by video conference room systems 616 and/or 618, respectively. Use cases also support stereo capture and immersive rendering of stereo audio signals for home theatre systems 620, and computer 612 for mono capture and immersive rendering of audio signals for virtual reality (VR) gear 622 and immersive content ingest 624.

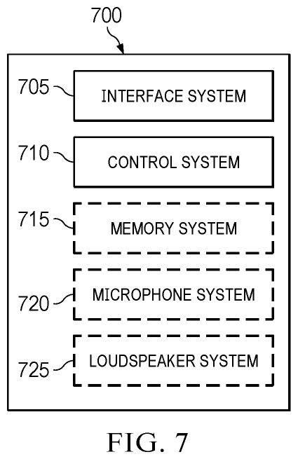

FIG. 7 is a block diagram that shows examples of components of an apparatus capable of implementing various aspects of this disclosure. As with other figures provided herein, the types and numbers of elements shown in FIG. 7 are merely provided by way of example. Other implementations may include more, fewer and/or different types and numbers of elements. According to some examples, the apparatus 700 may be configured for performing at least some of the methods disclosed herein. In some implementations, the apparatus 700 may be, or may include, a television, one or more components of an audio system, a mobile device (such as a cellular telephone), a laptop computer, a tablet device, a smart speaker, or another type of device.

According to some alternative implementations the apparatus 700 may be, or may include, a server. In some such examples, the apparatus 700 may be, or may include, an encoder. Accordingly, in some instances the apparatus 700 may be a device that is configured for use within an audio environment, such as a home audio environment, whereas in other instances the apparatus 700 may be a device that is configured for use in “the cloud,” e.g., a server.

In this example, the apparatus 700 includes an interface system 705 and a control system 710. The interface system 705 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 705 may, in some implementations, be configured for exchanging control information and associated data with audio devices of the audio environment. The control information and associated data may, in some examples, pertain to one or more software applications that the apparatus 700 is executing.

The interface system 705 may, in some implementations, be configured for receiving, or for providing, a content stream. The content stream may include audio data. The audio data may include, but may not be limited to, audio signals. In some instances, the audio data may include spatial data, such as channel data and/or spatial metadata. In some examples, the content stream may include video data and audio data corresponding to the video data.

The interface system 705 may include one or more network interfaces and/or one or more external device interfaces, such as one or more universal serial bus (USB) interfaces. According to some implementations, the interface system 705 may include one or more wireless interfaces. The interface system 705 may include one or more devices for implementing a user interface, such as one or more microphones, one or more speakers, a display system, a touch sensor system and/or a gesture sensor system. In some examples, the interface system 705 may include one or more interfaces between the control system 710 and a memory system, such as the optional memory system 715 shown in FIG. 7. However, the control system 710 may include a memory system in some instances. The interface system 705 may, in some implementations, be configured for receiving input from one or more microphones in an environment.

The control system 710 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 710 may reside in more than one device. For example, in some implementations a portion of the control system 710 may reside in a device within one of the environments depicted herein and another portion of the control system 710 may reside in a device that is outside the environment, such as a server, a mobile device (e.g., a smartphone or a tablet computer), etc. In other examples, a portion of the control system 710 may reside in a device within one environment and another portion of the control system 710 may reside in one or more other devices of the environment. For example, a portion of the control system 710 may reside in a device that is implementing a cloud-based service, such as a server, and another portion of the control system 710 may reside in another device that is implementing the cloud-based service, such as another server, a memory device, etc. The interface system 705 also may, in some examples, reside in more than one device.

In some implementations, the control system 710 may be configured for performing, at least in part, the methods disclosed herein. According to some examples, the control system 710 may be configured for implementing methods of determining gain parameters, applying gain transition functions, determining inverse gain transition functions, applying inverse gain transition functions, distributing bits for gain control with respect to a bitstream, or the like.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 715 shown in FIG. 7 and/or in the control system 710. Accordingly, various innovative aspects of the subject matter described in this disclosure can be implemented in one or more non-transitory media having software stored thereon. The software may, for example, include instructions for determining gain parameters, applying gain transition functions, determining inverse gain transition functions, applying inverse gain transition functions, distribution bits for gain control with respect to a bitstream, etc. The software may, for example, be executable by one or more components of a control system such as the control system 710 of FIG. 7.

In some examples, the apparatus 700 may include the optional microphone system 720 shown in FIG. 7. The optional microphone system 720 may include one or more microphones. In some implementations, one or more of the microphones may be part of, or associated with, another device, such as a speaker of the speaker system, a smart audio device, etc. In some examples, the apparatus 700 may not include a microphone system 720. However, in some such implementations the apparatus 700 may nonetheless be configured to receive microphone data for one or more microphones in an audio environment via the interface system 710. In some such implementations, a cloud-based implementation of the apparatus 700 may be configured to receive microphone data, or a noise metric corresponding at least in part to the microphone data, from one or more microphones in an audio environment via the interface system 710.

According to some implementations, the apparatus 700 may include the optional loudspeaker system 725 shown in FIG. 7. The optional loudspeaker system 725 may include one or more loudspeakers, which also may be referred to herein as “speakers” or, more generally, as “audio reproduction transducers.” In some examples, e.g., cloud-based implementations, the apparatus 700 may not include a loudspeaker system 725. In some implementations, the apparatus 700 may include headphones. Headphones may be connected or coupled to the apparatus 700 via a headphone jack or via a wireless connection, e.g., BLUETOOTH.

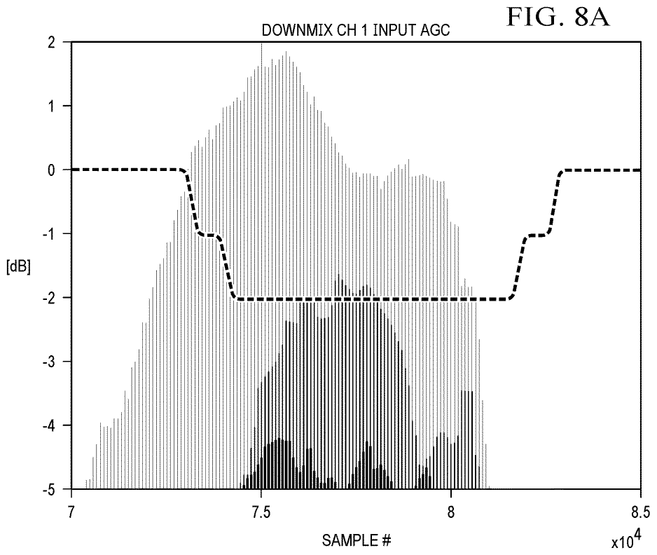

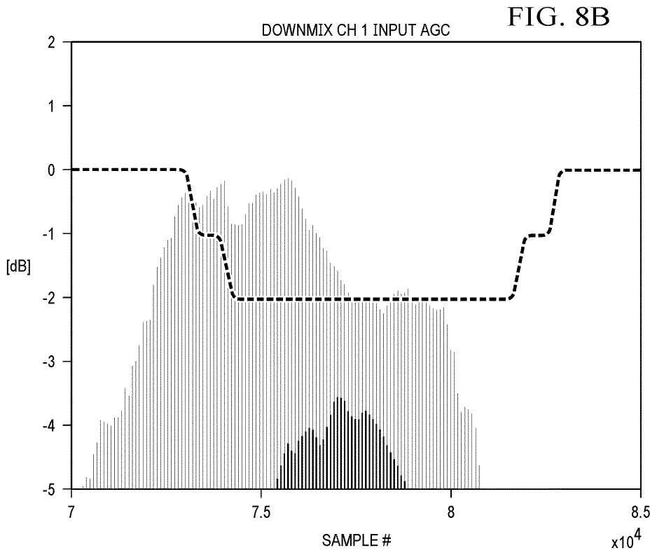

FIGS. 8A and 8B illustrate example implementations of the perceptually motivated gain control where a sample uniform Gain Control with DBSTEP=−1 dB at the encoder side. In this specific example one frame consists of 1024 samples. Sample amplitudes are represented as dotted lines, while the gain applied per sample is represented by a solid line. As can be seen in FIG. 8A, as soon as a frame would produce an overload at an encoder (amplitude larger than 0 dB), the gain function transitions from no attenuation (0 dB) to an attenuation of DBSTEP−0 dB=−1 dB. A further attenuation by DBSTEP is introduced when the input audio signal exceeds 1 dB.

The resulting attenuated downmixed audio signal is depicted in FIG. 8B. In this specific example, the value of DBSTEP is large enough, so that each sample is attenuated below the required threshold (0 dB).

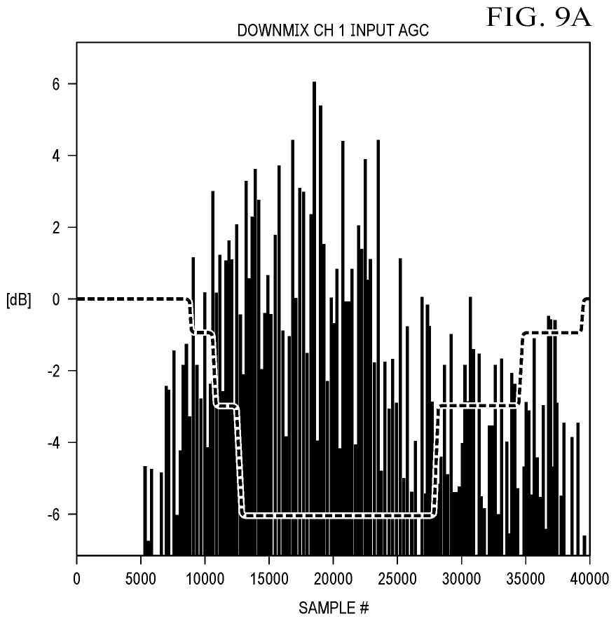

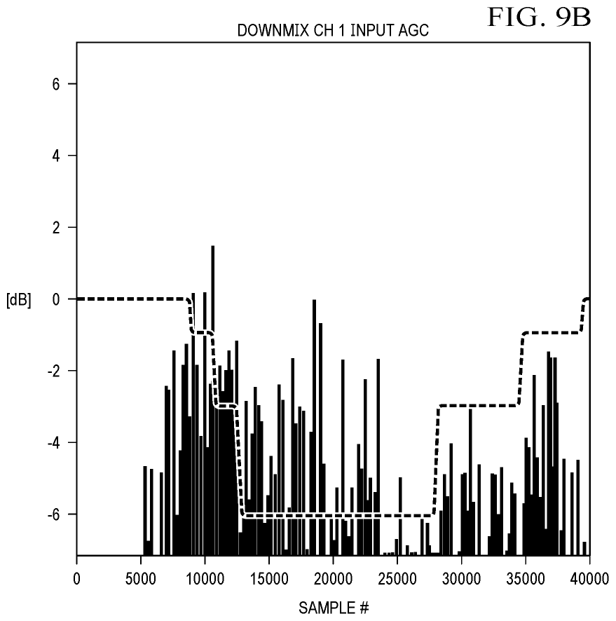

FIGS. 9A and 9B illustrate an example of “non-uniform” Gain Control with DBS=−1 dB and G_{T}={0, 1, 3, 6} yielding a set of attenuation values {DBS*Gr}={0, −1, −3, −6}dB or DBSTEP set of {−1, −2, −3} at the encoder side. As in FIGS. 8A and 8B, the amplitudes of the samples are depicted by dotted lines, while the gain function is depicted as a solid line. With a set of DBSTEP, the automatic gain control can react to overloads caused at the encoder by attenuating the signal with increasing values at each frame. As depicted in FIG. 9B, the gain transition step size is not large enough so that all sampled are below the required threshold (0 dB). This may lead to distortions when the audio signal is rendered at the decoder, but the distortions caused by the overload at the encoder are less noticeable than the distortions caused by very sudden gain changes.

Some aspects of present disclosure include a system or device configured, e.g., programmed, to perform one or more examples of the disclosed methods, and a tangible computer readable medium, e.g., a disc, which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor, e.g., a personal computer (PC) or other computer system or microprocessor, which may include an input device and a memory, which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements. The other elements may include one or more loudspeakers and/or one or more microphones. A general purpose processor configured to perform one or more examples of the disclosed methods may be coupled to an input device. Examples of input devices include, e.g., a mouse and/or a keyboard. The general purpose processor may be coupled to a memory, a display device, etc.

Another aspect of present disclosure is a computer readable medium, such as a disc or other tangible storage medium, which stores code for performing, e.g., by a coder executable to perform, one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

Various aspects and implementations of the present disclosure may also be appreciated from the following enumerated example embodiments (EEEs), which are not claims.
EEE1. A method of performing gain control on audio signals, the method comprising: obtaining a downmixed audio signal of an audio signal to be encoded;
   determining that an overload condition has occurred for a frame of the downmixed audio signal;
   responsive to determining that the overload condition has occurred, determining a gain transition function for the frame, wherein the gain transition function is based at least on a gain transition step size;
   applying the gain transition function to the frame to generate a gain adjusted frame of the downmixed audio signal; and
   providing the gain adjusted frame and information indicative of the gain transition function for encoding by an encoder.
EEE2. The method of claim EEE1, wherein the method further comprises:
   encoding the gain adjusted frame together with the information indicative of the gain transition function.
EEE3. The method of any previous claim, wherein obtaining a downmixed audio signal of an audio signal to be encoded comprises:
   receiving the downmixed audio signal; or
   determining the downmixed audio signal from the audio signal to be encoded.
EEE4. The method of any previous claim, wherein the audio signal is a higher order ambisonics, HOA, audio signal.
EEE5. The method of any previous claim, wherein the downmixed audio signal is a spatially encoded downmixed signal.
EEE6. The method of any previous claim, wherein the overload condition is a condition in which the frame of the downmixed audio signal exceeds a predefined signal range.
EEE7. The method of EEE 6, wherein the predefined signal range is a signal range expected by the encoder.
EEE8. The method of any previous claim, wherein the frame of the downmixed audio signal is a current frame and the gain transition function is further based on a previous gain transition function applied to a preceding frame of the current frame.
EEE9. The method of any previous claim, wherein the gain transition function further depends on a smoothing function based on the gain transition step size.
EEE10. The method of EEE 8, wherein the gain transition function comprises a transitory portion and a steady-state portion, and wherein the transitory portion corresponds to a transition from again associated with the preceding frame to the gain associated with the preceding frame adjusted by the gain transition step size.
EEE11. The method of EEE 10, wherein, the gain associated with the preceding frame adjusted by the gain transition step size is an attenuation by the gain transition step size or an amplification by the gain transition step size of the gain associated with the preceding frame depending on a gain adjustment target of the current frame.
EEE12. The method of EEEs 10 or 11, wherein a length of the transitory portion is limited by a delay introduced by a codec utilized by the encoder.
EEE13. The method of EEE 12, wherein the length of the transitory portion is equal to or less than the number of samples used for an encoding operation by the encoder.
EEE14. The method of any one of EEEs 10 to 13, wherein a length of the transitory portion is greater than 1 sample.
EEE15. The method of any previous claim, wherein the gain transition function is defined as

$$t ( DBSTEP , l , j ) = \{ \begin{matrix}\begin{matrix}{p ( DBSTEP , l , j )}^{( e ( j ) - e ( j - 1 ) )} * \\ t ( DBSTEP , L - 1 , j - 1 )\end{matrix} , & l = 0 … {l}_{end} \\ \begin{matrix}{p ( DBSTEP , {l}_{end} , j )}^{( e ( j ) - e ( j - 1 ) )} * \\ t ( DBSTEP , L - 1 , j - 1 )\end{matrix} , & l = {l}_{end} + 1 … L - 1\end{matrix}$$

wherein DBSTEP is the gain transition step size, l is a sample index, j is a frame index, p(is a smoothing function, l_{end} represents the right-most index for which p( ) is defined and L is the number of samples of one frame.
EEE16. The method of any previous claim, wherein the gain transition step size is a predefined value.
EEE17. The method of any previous claim, wherein the gain transition step size is determined from a set of predefined values of increasing size.
EEE18. The method of EEE 17, wherein the method further comprises:
   determining an overload amount caused by the frame of the downmixed audio signal;
   determining the gain transition step size from the set of predefined values of increasing size depending on the overload amount.
EEE19. The method of any previous claim, wherein the gain transition step size is determined based on a perceptive quality listening test or an objective quality measurement.
EEE20. The method of EEE 19, wherein the perceptive quality listening tests is a Multi-Stimulus Test with Hidden Reference and Anchor, MUSHRA.
EEE21. The method of any previous claim, wherein applying the gain transition function to the frame for generating a gain adjusted frame of the downmixed signal comprises:
   applying the gain transition function to samples of the downmixed audio signal, wherein a total number of the samples corresponds to the frame of the downmixed audio signal.
EEE22. The method of EEE 2 or any one of EEEs 3 to 21 when depending on claim 2, wherein encoding the gain adjusted frame together with the information indicative of the gain transition function comprises:
   determining an encoding scheme based on the gain transition function.
EEE23. The method of EEE 22, wherein determining an encoding scheme based on the gain transition function comprises:
   determining the encoding scheme based on the gain transition step size.
EEE24. The method of EEE 22, wherein determining an encoding scheme based on the gain transition function comprises:
   determining the encoding scheme based on whether the gain transition function was able to remove the overload condition.
EEE25. The method of any one of EEEs 22 to 24, wherein the encoding scheme is one of Modified Discrete Cosine Transformation, MDCT, or Algebraic Code Excited Linear Prediction, ACELP.
EEE26. The method of any previous claim, wherein the gain adjusted frame is an attenuated frame or an amplified frame.
EEE27. A method of performing gain control on audio signals, the method comprising:
   receiving, at a decoder, an encoded frame of an audio signal;
   decoding the encoded frame of an audio signal to obtain a frame of a downmixed audio signal and information indicative of gain control applied by an encoder;
   determining an inverse gain transition function to be applied to the frame of the downmixed audio signal based at least in part on the information indicative of gain control applied by the encoder, wherein the information indicative of gain control applied by the encoder comprises a gain transition step size; and
   applying the inverse gain transition function to the frame of the downmixed audio signal.
EEE28. The method of EEE 27, wherein the method further comprises:
upmixing the downmixed audio signal to generate an upmixed audio signal, wherein the upmixed audio signal is suitable for rendering.
EEE29. The method of EEE 28, further comprising rendering the upmixed signal to produce rendered audio data.
EEE30. The method of EEE 29, further comprising playing back the rendered audio data using one or more of a loudspeaker or headphones.
EEE31. The method of any one of EEEs 27 to 30, wherein the information indicative of gain control applied by the encoder further comprises information indicative of a smoothing function.
EEE32. The method of any one of EEEs 27 to 31, wherein the inverse gain transition function is determined by inverting a gain transition function applied by the encoder.
EEE33. The method of any one of EEEs 27 to 32, wherein the inverse gain transition function comprises a transitory portion and a steady-state portion.
EEE34. The method of EEE 33, wherein a length of the transitory portion is limited by a delay introduced by a codec utilized by the decoder.
EEE35. An apparatus configured for implementing the method of any one of EEEs 1-34.
EEE36. A program comprising instructions that when executed by a processing device cause the processing device to carry out the method according to any one of EEEs 1-34.
EEE37. A storage medium storing the program of EEE 36.
EEE38. A method for performing gain control on audio signals, the method comprising:
   receiving, by an automatic gain control system, a spatially encoded downmix audio signal;
   determining that an overload condition occurred for one or more frames of the received signal;
   responsive to the overload condition, generating an attenuated signal by applying a gain function to the received signal to attenuate the overload, the gain function being dependent on (1) an attenuation level parameter, (2) a gain function shape that specifies a respective attenuation level for each of the one or more frames, or (3) a combination of the attenuation level parameter and the gain function shape; and
   providing the attenuated signal and a representation of the attenuation level parameter to a core encoder for encoding.
EEE39. The method of EEE 38, wherein the attenuation level parameter includes a table of numbers, each number corresponding to a respective attenuation level to be consecutively applied to the one or more frames.
EEE40. The method of EEE 39, wherein each number has a same value, indicating that each step of attenuation attenuates the signal by a same amount.
EEE41. The method of EEE 39, wherein the numbers increase in value, indicating that each step of attenuation attenuates the signal by an amount that is higher than a previous step.
EEE42. The method of any of EEEs 38-41, comprising steering the core encoder to encode the audio signal using different encoding schemes based on the attenuation level parameter.
EEE43. The method of any of EEEs 38-42, comprising changing the gain function shape based on different values of the attenuation level parameter.
EEE44. An apparatus configured for implementing the method of any one of EEEs 38-43.
EEE45. One or more non-transitory media having software stored thereon, the software including instructions for controlling one or more devices to perform the method of any one of EEEs 38-43.

1. A method of performing gain control on audio signals, the method comprising:
obtaining a downmixed audio signal of an audio signal to be encoded;
determining that an overload condition has occurred for a frame of the downmixed audio signal;
responsive to determining that the overload condition has occurred, determining a gain transition function for the frame, wherein the gain transition function is based at least on a gain transition step size;
applying the gain transition function to the frame to generate a gain adjusted frame of the downmixed audio signal; and
providing the gain adjusted frame and information indicative of the gain transition function for encoding by an encoder.

2. The method of claim 1, wherein the method further comprises:
encoding the gain adjusted frame together with the information indicative of the gain transition function.

3. The method of claim 1, wherein obtaining a downmixed audio signal of an audio signal to be encoded comprises:
receiving the downmixed audio signal; or
determining the downmixed audio signal from the audio signal to be encoded.

4. The method of claim 1, wherein the audio signal is a higher order ambisonics, HOA, audio signal.

5. The method of any previous claim 1, wherein the downmixed audio signal is a spatially encoded downmixed signal.

6. The method of claim 1, wherein the overload condition is a condition in which the frame of the downmixed audio signal exceeds a predefined signal range, and optionally wherein the predefined signal range is a signal range expected by the encoder.

7. (canceled)

8. The method of claim 1, wherein the frame of the downmixed audio signal is a current frame and the gain transition function is further based on a previous gain transition function applied to a preceding frame of the current frame.

9. The method of claim 1, wherein the gain transition function further depends on a smoothing function based on the gain transition step size;
wherein the gain transition function optionally comprises a transitory portion and a steady-state portion, wherein the transitory portion corresponds to a transition from a gain associated with the preceding frame to the gain associated with the preceding frame adjusted by the gain transition step size; and
wherein the gain associated with the preceding frame is optionally adjusted by the gain transition step size as an attenuation by the gain transition step size or an amplification by the gain transition step size of the gain associated with the preceding frame depending on a gain adjustment target of the current frame.

10. (canceled)

11. (canceled)

12. The method of claim 9, wherein a length of the transitory portion is limited by a delay introduced by a codec utilized by the encoder, and wherein the length of the transitory portion is optionally equal to or less than the number of samples used for an encoding operation by the encoder.

13. (canceled)

14. The method of claim 9, wherein a length of the transitory portion is greater than 1 sample.

15. The method of claim 1, wherein the gain transition function is defined as
$$t ( DBSTEP , l , j ) = \{ \begin{matrix}\begin{matrix}{p ( DBSTEP , l , j )}^{( e ( j ) - e ( j - 1 ) )} * \\ t ( DBSTEP , L - 1 , j - 1 )\end{matrix} , & l = 0 … {l}_{end} \\ \begin{matrix}{p ( DBSTEP , {l}_{end} , j )}^{( e ( j ) - e ( j - 1 ) )} * \\ t ( DBSTEP , L - 1 , j - 1 )\end{matrix} , & l = {l}_{end} + 1 … L - 1\end{matrix}$$
wherein DBSTEP is the gain transition step size, l is a sample index, j is a frame index, p( ) is a smoothing function, l_{end} represents the right-most index for which p( ) is defined and L is the number of samples of one frame.

16. The method of claim 1, wherein the gain transition step size is a predefined value;
wherein the gain transition step size is optionally determined from a set of predefined values of increasing size, based on a perceptive quality listening test or an objective quality measurement, wherein the perceptive quality listening tests is a Multi-Stimulus Test with Hidden Reference and Anchor, MUSHRA.

17. (canceled)

18. The method of claim 16, wherein the method further comprises:
determining an overload amount caused by the frame of the downmixed audio signal;
determining the gain transition step size from the set of predefined values of increasing size depending on the overload amount.

19. (canceled)

20. (canceled)

21. The method of claim 1, wherein applying the gain transition function to the frame for generating a gain adjusted frame of the downmixed signal comprises:
applying the gain transition function to samples of the downmixed audio signal, wherein a total number of the samples corresponds to the frame of the downmixed audio signal.

22. The method of claim 3, wherein encoding the gain adjusted frame together with the information indicative of the gain transition function comprises:
determining an encoding scheme based on the gain transition function;
wherein determining an encoding scheme based on the gain transition function optionally comprises:
determining the encoding scheme based on the gain transition step size; or
determining the encoding scheme based on whether the gain transition function was able to remove the overload condition; and
wherein the encoding scheme optionally is one of Modified Discrete Cosine Transformation, MDCT, or Algebraic Code Excited Linear Prediction, ACELP.

23. (canceled)

24. (canceled)

25. (canceled)

26. The method of claim 1, wherein the gain adjusted frame is an attenuated frame or an amplified frame.

27. (canceled)

28. (canceled)

29. (canceled)

30. (canceled)

31. (canceled)

32. (canceled)

33. (canceled)

34. (canceled)

35. An apparatus configured for implementing the method of claim 1.

36. A program comprising instructions that when executed by a processing device cause the processing device to carry out the method according to claim 1.

37. A non-transitory computer-readable medium storing instructions that, upon execution by one or more processors, cause the one or more processors to perform the method of claim 1.

38. A system comprising:
one or more processors; and
a non-transitory computer-readable medium storing instructions that, upon execution by one or more processors, cause the one or more processors to perform the method of claim 1.
